(19) United States
(12) Patent Application Publication
(10) Pub. No.: US 2021/0300379 A1
(43) Pub. Date: Sep. 30, 2021

(54) Determining the Course of a Lane

(71) Applicant: Bayerische Motoren Werke Aktiengesellschaft, Muenchen (DE)

(72) Inventors: Andreas HACKELOEER, Muenchen (DE); Martin LIEBNER, Muenchen (DE); David PANNEN, Muenchen (DE); Thomas SCHUTZMEIER, Unterhaching (DE)

(21) Appl. No.: 17/264,898

(22) PCT Filed: Jul. 8, 2019
(86) PCT No.: PCT/DE2019/100638

§ 371 Date: Feb. 1, 2021

(30) Foreign Application Priority Data
Aug. 2, 2018 (DE) 10 2018 212 916.9

(51) Int. Cl. B60W 30/18; B60W 40/04; B60W 50/00; G06K 9/00

(52) U.S. Cl. CPC B60W 30/18163; B60W 30/18154; B60W 40/04; B60W 2556/45; G06K 9/00798; B60W 2552/53; B60W 2554/4041; B60W 50/0097

(57) ABSTRACT

A road having a lane includes a first and a second segment having no branch-offs, and a third segment, which lies between the first and second segments and in the range of which the road forms a single-level traffic junction with another road. A method for determining the course of the lane includes steps of determining driving trajectories of a plurality of motor vehicles in the lane in the range of the first and/or the second segment; determining the course of the lane in the range of the first and second segments on the basis of the driving trajectories; determining a probable driving trajectory of the motor vehicles in the range of the third segment on the basis of the determined course in the first and second segments; and determining the course of the lane in the range of the third segment.

### BACKGROUND AND SUMMARY OF THE INVENTION

The invention relates to determining a course of a lane of a road. In particular, the invention relates to determining a course of a lane in the region of an intersection of two roads.

A motor vehicle can be automatically controlled in the longitudinal and/or transverse direction. For this purpose, on the one hand, data that is collected from the surroundings of the motor vehicle can be used and, on the other hand, the control can be based on data from a highly accurate geographical map. Creating a map of this kind is very complex as this requires a large number of road sections to be surveyed with a high degree of precision and sufficient frequency.

DE 10 2013 208 521 A1 proposes determining a highly accurate map based on observations of a fleet of vehicles.

If survey data that was produced on board a motor vehicle is collected unprocessed at a central location, this may require a disproportionately large bandwidth. If, on the other hand, the data is pre-processed locally by the motor vehicle, only limited processing resources can usually be used for this. There is the risk of the data becoming contaminated as a result of the processing or of details going missing. In particular in the region of an area that is difficult to map, for example an intersection of two roads, fleet-based mapping may be difficult.

One object of the invention is to provide an improved technique for collective mapping, which preferably enables a high degree of accuracy and being up-to-date whilst at the same time using a low transmission bandwidth between the motor vehicles and a central location.

A road with a lane comprises a first and a second section without any branch-offs, as well as a third section which is located between the first and the second section and in the region of which the road forms a same-level traffic junction with another road.

According to a first aspect of the present invention, a method for determining the course of the lane comprises steps for determining driving trajectories of a plurality of motor vehicles on the lane in the region of the first and/or the second section, determining the course of the lane in the region of the first and second section based on the driving trajectories, determining a likely driving trajectory of the motor vehicles in the region of the third section based on the specific course on the first and second section and determining the course of the lane in the region of the third section.

The same-level traffic junction can in particular be designed as a T-junction, turning, intersection, on-ramp or off-ramp. The course of the lane can be better determined by splitting it into three sections in particular in the region of the traffic junction.

A driving trajectory can in particular be determined based on a series of absolute position determinations and odometry. The absolute position determination can in particular be determined by means of a receiver of a satellite-based navigation system. Other types of determination are, however, also possible, such as by means of visual detection of a landmark and triangulation. The odometry can in particular determine a distance traveled by the motor vehicle and, for example, operate on the basis of a wheel speed of a wheel of the motor vehicle. Odometer information can also be determined based on other sensors. By way of example, a rotation or a translation of the motor vehicle can be determined by means of an acceleration or rotational speed sensor. A movement of the motor vehicle in direction and/or speed can also be determined based on a contactless sensor such as a camera, radar sensor, LIDAR sensor or an ultrasonic sensor. The sensor is preferably imaging and can further preferably be optical by performing light- or radiowave-based scanning. The determination can be carried out on the basis of an optical flow. Such a method is also known as “visual odometry”. In general, odometer information is a relative size which relates to a current or past position of the motor vehicle and can preferably comprise a direction component, a distance component and/or a speed component.

In a further embodiment, the location of at least one point landmark is determined in the region of the first or second section, wherein the driving trajectory in the region of the third section is determined with regard to the specific point landmark. The landmark can, for example, comprise a lane boundary, a road sign or another detectable object in the vicinity of the motor vehicle, the position of which is known on board the motor vehicle, for example because it is marked on a road map. Determining a position of the motor vehicle and scanning the object in the vicinity can be performed in an integrated manner, for example by means of an SLAM algorithm (Simultaneous Localization and Mapping).

The point landmark can comprise an object located near the lane, for example an emergency telephone, a road sign or signpost or a road marking. In particular when the object is relevant for the traffic on the lane, it can be easily detectable and identifiable and its position can be known with sufficient accuracy.

The road can comprise several lanes in the same direction. A distinction of a lane change from a motor vehicle leaving or entering the lane can be made with improved accuracy based on the connection information from the first and second section. If the road comprises two lanes, whose right lane markings correspond to one another and whose left lane markings correspond to one another, the lane which the motor vehicle is in cannot be determined based on observed lanes. Such a situation arises, for example, when there are four or more lanes between which lane changes are permitted; in this case, there can be two or more lanes in the center which are delimited on both sides by broken lines.

If changes between adjacent lanes can be identified with sufficient reliability, a lane driven on by one of the motor vehicles can be determined by determining an initial lane assignment, i.e. the lane which the motor vehicle is in when entering a section, and subsequently determining the lane being driven on based on the initial lane and a sequence of lane changes. In other words, an initial lane which one of the motor vehicles is in when entering one of the sections without any branch-offs can be determined, and the course of the lane can be determined based on a change of the lane driven on by the motor vehicle. The course of a section between two lane changes can be determined based on the trajectory of the motor vehicle and the lane used.

For this purpose, the sequence of the motor vehicle changing between adjacent lanes of the road can be determined. A probability of the motor vehicle being in one of the lanes when entering one of the sections without any branch-offs can be determined based on the sequence. A measure of the correspondence between the sequence and a known arrangement of lanes can thus be considered. By way of example, a road can comprise three lanes. If two lane changes to the left are determined, the outermost right lane can be determined to be the initial lane. An initial lane assignment can, for example, also be determined to be unlikely if the motor vehicle performs two lane changes to the right in succession even though there is only one lane to the right of the initial lane. This initial assignment would also be equally unlikely if the vehicle observes a broken line on its right side following the first lane change to the right.

A high probability of the motor vehicle driving on an initial lane taken when entering one of the sections without any branch-offs can be determined if the driving trajectory of the motor vehicle on the road is close to a course that can be expected based on the lane taken. The course can be determined two or three-dimensionally.

The course to be expected can be determined by initially determining points of intersection of trajectories of a plurality of motor vehicles by a predetermined road cross-section of the road, then determining boundaries between adjacent lanes based on the points of intersection and finally determining the course that can be expected based on the boundaries (“spatial prior fit”).

A probability of the motor vehicle being in one of the lanes when entering one of the sections without any branch-offs can be determined based on a distance of the trajectory from the specific boundaries.

A number of lanes of the road can be determined based on lane markings between lanes observed by a plurality of motor vehicles (“coverage”). In this case, a lane can be considered non-existent if its lane marking was observed by less than a certain proportion of all motor vehicles when driving through the respective stretch of road.

In a further embodiment, permission to change lane in the region of the third section is determined and the likely driving trajectory is determined based on the specific permission. If it is prohibited to overtake in the region of the traffic junction, for example, a lane change by a motor vehicle detected in this region can be considered a prohibited maneuver and an assigned trajectory can be discarded altogether.

Certain courses of lanes can be connected on adjacent sections to form an overall course. A road map of practically any size can thus be generated from a plurality of individual sections of lanes. The road map can have a high degree of accuracy with regard to the course of lanes. The road map can be supplemented with further information, in particular with information from a less accurate road map, which can be used, for example, only for navigation purposes, but not for a highly-precise application such as automatic control of longitudinal and/or transverse dynamics of a motor vehicle. The inaccurate map can thus be converted into a highly accurate map. The accuracy and/or reliability of the road map can be enhanced with an increasing number of in particular current observations of trajectories of different motor vehicles. The use of special measuring vehicles or an evaluation of further sources of information such as satellite images can be dispensed with.

A difference between the overall course and a taken course can be determined and a correction of the taken course can be determined based on the difference.

According to a second aspect, a device comprises a communication device for receiving certain driving trajectories of a plurality of motor vehicles, wherein the driving trajectories respectively lead over the first and/or the second section of the road, and a processing device. The processing device is configured to determine a course of a lane in the region of the first and second section based on the driving trajectories, and a likely driving trajectory of the motor vehicles in the region of the third section based on the specific course on the first and second section.

The processing device can be configured to perform a method described herein either in part or in full. For this purpose, the processing device can comprise a programmable microcomputer or microcontroller and the method can be available in the form of a computer program product with program code means. The computer program product can also be stored on a computer-readable data carrier. Features or advantages of the method can be transferred to the device or vice versa.

The invention is now described in more detail with reference to the appended drawings.

### BRIEF DESCRIPTION OF THE DRAWINGS

FIG. 1 shows a system.

FIG. 2 shows a flow chart of a method.

FIG. 3 shows an exemplary intersection of two roads.

### DETAILED DESCRIPTION OF THE DRAWINGS

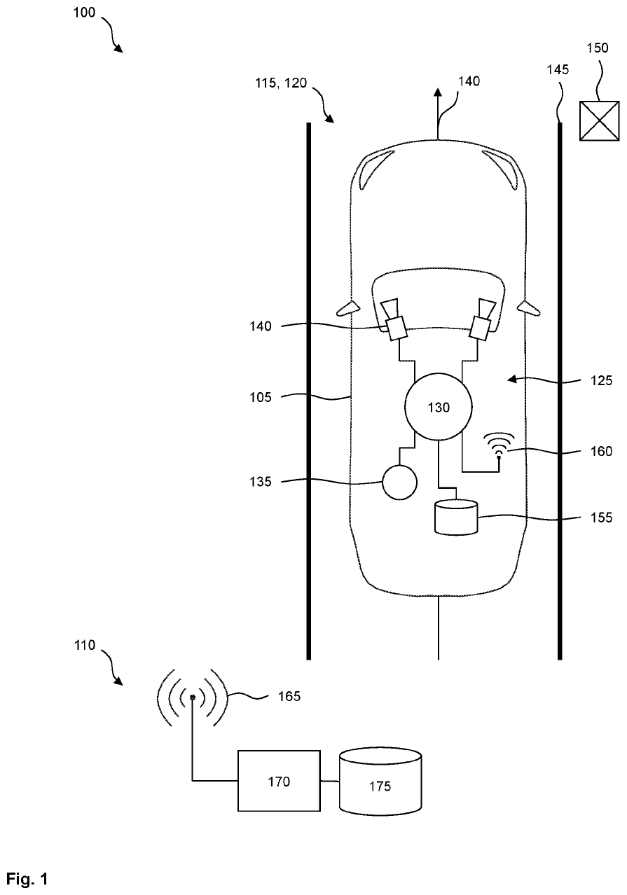

FIG. 1 shows a system 100 having a motor vehicle 105 and a central location 110. A road 115 comprises a lane 120 on which the motor vehicle 105 can travel. The motor vehicle 105 comprises a device 125 which comprises a processing device 130 and a positioning device 135.

The positioning device 135 is configured to determine an absolute position of the motor vehicle 105. The processing device 130 can determine a driving trajectory 140 of the motor vehicle 105 based on a series of specific positions. The driving trajectory 140 can additionally be determined by means of visual odometry. For this purpose, the vicinity of the motor vehicle 105 can be scanned by means of one or several preferably contactless sensors 142. A sensor 142 can in particular comprise an optical sensor such as a camera, but a radar sensor, a lidar sensor or an ultrasonic sensor can also be provided, for instance. A lane boundary 145 of the lane 120 can be determined in the region of the motor vehicle 105 based on the scanning. Moreover, a landmark 150 can be determined which must not usually be driven over and can be near or above the road 115. The landmark 150 can, for example, comprise a traffic light, a traffic sign or a beacon. An intended position of the landmark 150 can be known or unknown.

In order to determine the driving trajectory 140, it can be observed how a landmark 150 moves through a scanning region of the sensor 142 when the motor vehicle 105 is traveling. The movement of the motor vehicle 105 relative to the landmark 150 and thus to the road 115 can be determined from this observation. The determination can be better carried out if the predetermined position of the landmark 150 is known. In some cases, a deviation of an observed position of the landmark 150 from the predetermined position can also be determined as part of the observation. The predetermined position can, for example, be stored in a data memory 155. Data stored there can in particular comprise map data which can also comprise a predetermined course of the road 115 or of the lane 120.

The driving trajectory 140 can further be determined based on further observations of a sensor or system on board the motor vehicle 105. A sensor of this type can, for example, comprise a speed sensor on a wheel of the motor vehicle 105. It is preferable for the device 125 to further comprise a communication device 160 which in particular can be configured for wireless communication. A wireless network such as a cellular network can be used for communication.

The central location 110 can be implemented as a server or, for example, also as a service in a cloud. The central location 110 comprises a communication device 165, a processing device 170 and a data memory 175. The communication devices 160 and 165 are preferably configured for mutual communication, wherein some of the transfer can also be wired. The central location 110 is configured to receive and process driving information of a plurality of motor vehicles 105. The central location 110 is also preferably configured to determine the course of a lane 120 driven over by motor vehicles 105. It can also be determined whether the specific course deviates from a predetermined course which is specified in the abovementioned map data. In this course, a correction of the predetermined course can be determined. In one embodiment, a similar correction regarding a position, existence or nature of a landmark 150 can be determined on the basis of a plurality of pieces of information from motor vehicles 105.

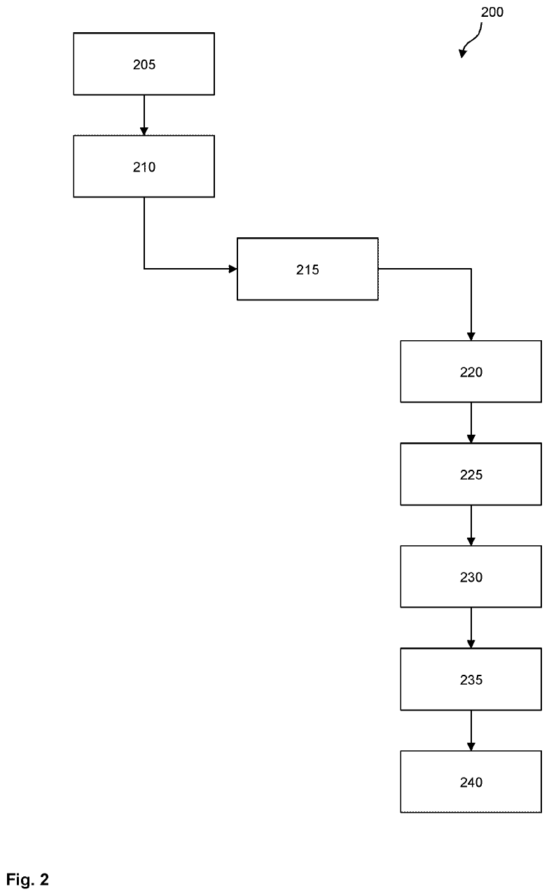

FIG. 2 shows a flow chart of a method 200 which can be carried out in particular on the basis of a system 100 such as that of FIG. 1. In a first step 205, a driving trajectory 140 of the motor vehicle 105 can be determined. The determination can be carried out based on absolute position determinations, in particular by means of the positioning device 135, or on the basis of a relative position, for example as an odometric determination. It can also be determined in a step 210 whether the road 115 which the motor vehicle 105 is on is free of branch-offs.

In a step 210, it can be determined that the determined driving trajectory 140 is on a section of the road 115 driven on without any branch-offs. This step can be determined in various embodiments before, during or after the driving trajectory 140 has been determined. An odometric sensor system on board the motor vehicle 105 can in particular be used for determining the lack of branch-offs. Information about roads to be taken into consideration that merge or branch off can be found in map data.

The specific driving trajectory 140 is sent to the central location 110 in a step 215. The central location 110 is configured to receive a plurality of driving trajectories 140 from motor vehicles 105 traveling on the road 115. If a received driving trajectory 140 extends beyond a region of the road 115 in which it is free of branch-offs, the central location 110 can also correspondingly truncate the driving trajectory 140 to an area free of branch-offs.

In a step 220, the central location 110 can determine a corresponding lane 120 on the section of the road 115 without any branch-offs with respect to a plurality of received driving trajectories 140. A section of a lane 120 driven on by the motor vehicle 105 can be determined on the basis of a lane change which was observed on a section free of branch-offs. A lane change can alternatively be determined by the motor vehicle 105 or by the remote location 110. A corresponding determination can be carried out with regard to another section of the road 115, wherein the two sections are on different sides of another section in which there is a branch-off.

In a step 225, a likely or the most likely of several possible driving trajectories 140 of the motor vehicles 105 can be determined in the region of the branch-off. On this basis, a course of the lane 120 in the region of the branch-off can be determined in a step 230.

Courses of lanes 120 on sections of the road 115 can be combined to form a superordinate course in a step 235. In this case, the specific courses can in particular be merged with further data which can, for example, be found on a geographical map of the region in question. On the basis of the determined courses, changes, so-called patches, can be determined for the existing geographical map. The existing map can be a conventional map which can be used for navigation having an accuracy in the range of one or several meters or a high definition (HD) map having an accuracy in the range of one or several centimeters.

In order to determine a patch for an existing geographical map, a further SLAM optimization can be applied to calculate updated geometries. The optimization attempts in particular to match available data such that deviations or errors are minimized. In this case, it must be ensured that the newly determined lane markings are seamlessly linked with those already present on the map. For each start and each end of a lane marking in the longitudinal direction, a hard factor can be determined which forces the locations of the corresponding points to lie exactly where they are within the map. Such a hard factor can also be referred to as a constraint and remains unchanged during the optimization. Finally, the result can be converted into the data structure of a digital map.

The course of the lane markings can be determined by means of an approach known as “spatial prior fit”. A spatial prior represents an assumption about the signed orthogonal distance of a lane marking to the center line of a lane 120. For each center line segment, it can be determined by grouping the signed lateral distances of the observed lane markings, which are associated with this segment, or a segment, which has the same lane marking configuration and is at most five center line steps away. In one embodiment, an expectation maximization clustering is used with the same number of clusters as the lane markings in the lane marking configuration of the segment. The resulting clusters can be sorted by lateral distance and given a lane marking number.

For each traversing and assumed initial lane assignment, the distance d between each lane marking observation and the corresponding spatial prior can thus be calculated. By applying the function with the decay parameter g=7.5, a score in the interval [0, 1] can be determined for each of the observations. The overall score of a sub-hypothesis can be calculated as the mean score of its observations, and the overall spatial prior fit score as the mean score over all traversals.

Finally, a correction can be determined in a step 240, in order to get an adopted course of a lane 120 close to a specific course. The correction can be provided to one or several motor vehicles 105, for example in the form of a map update. It can be provided in particular by means of the communication devices 160, 165.

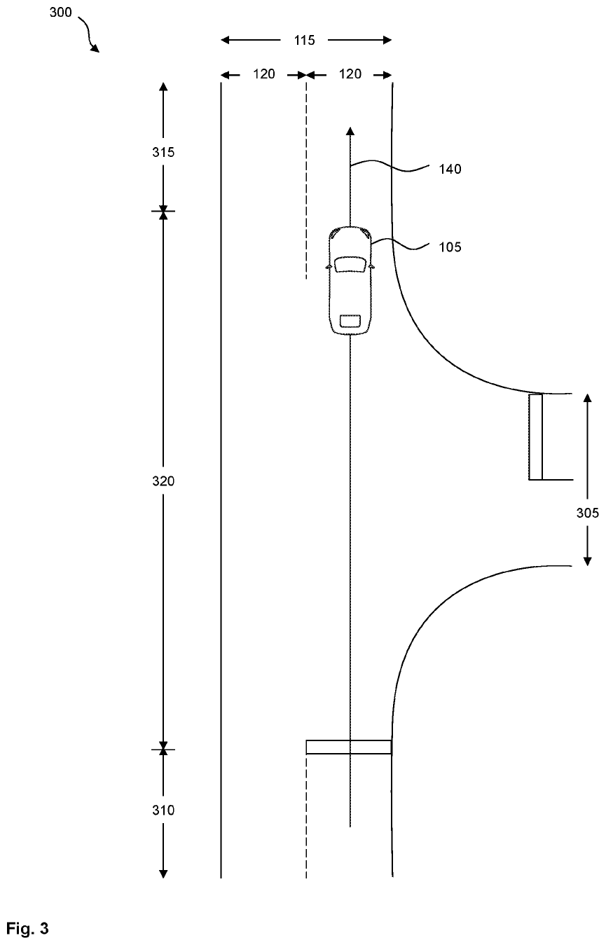

FIG. 3 shows an intersection 300 of an exemplary road 115 with a further road 305. In the interests of clarity, only lanes 115 in one direction of travel are considered here in the illustration from bottom to top. The road 115 comprises two parallel lanes 120, by way of example. In the region illustrated, the road 315 extends on a first section 310, a second section 315 and an intermediate third section 320. The sections 310 and 315 are free of branch-offs and, in the region of the third section 320, there is potentially the opportunity for a motor vehicle 105 to change between the road 115 and the other road 305.

The ground markings (also: lane markings) illustrated in FIG. 3 in the region of the third section 320, which respectively denote a lateral delimitation of a lane 120, are purely exemplary and not necessarily complete. Scanning carried out by an environmental sensor system 142, which is configured to identify ground markings, for example by means of a camera or a lidar sensor, does not usually distinguish between a broken and a solid ground marking. Further markings in the region of an intersection 300 such as a stop line, a limit line of a pedestrian crossing or a cycle path crossing or even a directional arrow for assigning a direction of travel to a lane 120 are not generally evaluated. The intermediate course of the road 115 can be better determined on the basis of statistical observations thanks to the proposed determination of the lane 120 on sections of a road 115 without any branch-offs and which are adjacent to an intersection, on-ramp or off-ramp.

### REFERENCE SIGNS

100 system
105 motor vehicle
110 central location
115 road
120 lane
125 device
130 processing device
135 positioning device
142 sensor
145 lane boundary
150 landmark
155 data memory
160 communication device
165 communication device
170 processing device
175 data memory
200 method
205 determining driving trajectory
210 road free of branch-offs?
215 sending driving trajectory
220 determining course of a lane
225 determining likely driving trajectory in intermediate region
230 determining course of the lane in the intermediate region
235 combining courses to form an overall course
240 determining correction
300 intersection
305 other road
310 first section
315 second section
320 third section

1.-15. (canceled)

16. A method for determining a course of a lane of a road, the method comprising the steps of:
determining a first section of the road without any branch-offs;
determining a second section of the road without any branch-offs;
determining a third section of the road, which is located between the first and the second sections, wherein the road forms a same-level traffic junction with another road in a region of the third section;
determining driving trajectories of a plurality of motor vehicles on the lane in a region of the first and/or the second section;
determining the course of the lane in the region of the first and second section based on the driving trajectories;
determining a probable driving trajectory of the motor vehicles in the region of the third section based on the determined course on the first and second sections; and
determining the course of the lane in the region of the third section.

17. The method according to claim 16, wherein
a driving trajectory is determined based on a series of absolute position determinations and odometry.

18. The method according to claim 17, wherein
a location of at least one point landmark is determined in the region of the first or second section, and
the driving trajectory in the region of the third section is determined with regard to the determined point landmark.

19. The method according to claim 18, wherein the point landmark comprises a lane marking.

20. The method according to claim 18, wherein the point landmark comprises an object located near the lane.

21. The method according to claim 16, wherein
an initial lane, in which one of the motor vehicles is in when entering one of the first and second sections without any branch-offs, is determined, and
the course of the lane is determined based on a change of the lane driven on by the motor vehicle.

22. The method according to claim 21, wherein
a sequence of the motor vehicle changing between adjacent lanes of the road is determined and a probability of the motor vehicle being in one of the lanes when entering one of the first and second sections without any branch-offs is determined based on the sequence.

23. The method according to claim 21, wherein
a high probability of the motor vehicle driving on an initial lane taken when entering one of the first and second sections without any branch-offs is determined if the driving trajectory of the motor vehicle on the road is close to a course that is expected based on the lane taken.

24. The method according to claim 23, wherein
points of intersection of trajectories of the plurality of motor vehicles are determined by a road cross-section of the road,
boundaries between adjacent lanes are determined based on the points of intersection, and
the course that is to be expected is determined based on the boundaries.

25. The method according to claim 24, wherein
a probability of the motor vehicle being in one of the lanes when entering one of the first and second sections without any branch-offs is determined based on a distance of the trajectory from the boundaries.

26. The method according to claim 16, wherein
a number of lanes of the road is determined based on lane markings between lanes observed by the plurality of motor vehicles.

27. The method according to claim 16, wherein
permission to change lane in the region of the third section is determined and the probable driving trajectory is determined based on the determined permission.

28. The method according to claim 16, wherein
certain courses of lanes on adjacent sections are connected to form an overall course.

29. The method according to claim 28, wherein
a difference between the overall course and a taken course is determined, and
a correction of the taken course is determined based on the difference.

30. A device, comprising:
a communication device that receives certain driving trajectories of a plurality of motor vehicles,
wherein the driving trajectories respectively lead over a first and/or a second section of a road without any branch-offs, wherein the road forms a same-level traffic junction with another road in a region of a third section which is located between the first and the second section; and
a processor configured to determine a course of a lane in the region of the first and second section based on the driving trajectories,
wherein the processor is further configured to determine a probable driving trajectory of the motor vehicles in the region of the third section based on the determined course on the first and second sections.
